(19) United States
(12) Patent Application Publication
(10) Pub. No.: US 2025/0296475 A1
(43) Pub. Date: Sep. 25, 2025

(54) VOLTAGE REGULATION OF SECONDARY POWER SOURCE FOR BATTERY SWAP ELECTRIC MACHINES

(71) Applicant: Caterpillar Inc., Peoria, IL (US)

(72) Inventors: Joshua Wade Dorothy, Dunlap, IL (US); Eric M. Andris, Dunlap, IL (US); Corey Allen Kauk, Elk River, MN (US); Michael J. Barngrover, Brimfield, IL (US); Steven Krause, Chillicothe, IL (US)

(73) Assignee: Caterpillar Inc., Peoria, IL (US)

(21) Appl. No.: 18/613,411

(22) Filed: Mar. 22, 2024

(51) Int. Cl. B60L 58/22; E02F 9/20; H02P 5/68

(52) U.S. Cl. CPC B60L 58/22; H02P 5/68; B60L 2200/40; B60L 2240/547; E02F 9/2091

(57) ABSTRACT

A system and method of swapping a primary battery of an electric machine may include storing, by the primary battery, a first amount of energy. A secondary battery may store a second amount of energy that is less than the first amount of energy. First electrical power may be supplied from the primary battery to at least one motor. A second voltage level of the secondary battery may be managed (e.g., boosted) to match a first voltage level of the primary battery in response to receiving a battery swap initiation signal during which the primary battery is to be electrically disconnected from the electric machine to enable second electrical power from the secondary battery to be supplied to the motor(s) therefrom.

### BACKGROUND

Electric machines, such as mining machines, may be beneficially powered by electrical storage batteries to allow the machines to be operated in environments that benefit from zero emissions, less noise production, and less heat production by diesel engines. The use of electric machines also reduces cost of operations. One problem that exists with operating electric machines is charging and swapping recharged batteries. Because such electric machines consume a lot of energy, the need to recharge batteries or other batteries is relatively frequent (e.g., every few hours). And, because the rechargeable batteries are large, recharging the rechargeable batteries is time-consuming (e.g., from 30 minutes to several hours). As a result, rather than having long downtime for the electric machines, the electric machines are configured to have the energy depleted rechargeable batteries swapped with a fully charged battery. However, the rechargeable batteries are considerably heavy (e.g., 1000 pounds (454 kg) or significantly larger) such that swapping a rechargeable battery generally requires the battery to be removed and placed onto a charger by the electric machine and then the electric machine to be driven to another charger on which a charged battery is positioned so that the charged battery may be installed on the electric machine.

To enable operation and maneuvering of the electric machine when the (primary) rechargeable battery is removed, a secondary rechargeable battery is often included on electric machines. As is understood, performing a “hot-swap” of the primary battery may mean that a secondary battery be installed on the electric machine and most subsystems (e.g., air conditioning, heaters, etc.) of the electric machine be disabled because operation using the secondary battery while swapping the primary battery may take upwards of six minutes or more and the secondary battery may not be suitable or practical to operate subsystems, such as air conditioning, heating, etc. Additionally, the process of “hot-swap” of batteries risks damaging electrically connected equipment in the machine because the secondary battery and primary battery may differ in operating condition, such as output voltage. As such, there is a need to improve the “hot-swap” process of an electric machine.

### SUMMARY

To overcome the shortcomings of performing a “hot-swap” of a primary battery of an electric machine, the principles described herein provide for an electric machine with a primary battery, secondary battery, and power electronics to support “hot-swapping” the primary battery and enable the electric machine to continuously operate to perform core functionality and maintain operations of subsystems, such as air conditioning, of the electric machine. The power electronics may include a power management circuit (e.g., buck/boost DC/DC circuit) that is configured to (i) match a voltage level of the secondary battery with the voltage level of a depleted primary battery prior to being electrically disconnected for recharging, (ii) support electrical supply demands of the electric machine so as to maintain operation of subsystems while the electric machine is being maneuvered during the battery swap operation, and (iii) match the voltage level of the secondary battery with that of a recharged primary battery that is reloaded onto the electric machine, thereby avoiding arcing or other undesired electrical phenomenon, such as a current surge, on a system DC power bus.

One embodiment of an electric machine may include at least one electric motor. A primary battery may be configured to store a first amount of energy and be removably connected to the electric machine. A secondary battery may be configured to store a second amount of energy that is less than the first amount of energy. The electric machine may include a system DC power bus, and power electronics in electrical communication with the system DC power bus with which at least one motor and the primary and secondary batteries are in electrical communication. The power electronics may be configured (i) to supply first electrical power from the primary battery to the motor(s) via the system DC power bus and (ii) to manage connection of a secondary battery to match a first voltage level of the primary battery in response to receiving a battery swap initiation signal that the primary battery is to be electrically disconnected from the system DC power bus to enable second electrical power from the secondary battery to be applied to the system DC power bus to supply electrical power to the motor(s).

One embodiment of a method of swapping a primary battery of an electric machine may include storing, by the primary battery, a first amount of energy. A secondary battery may store a second amount of energy that is less than the first amount of energy. First electrical power may be supplied from the primary battery to at least one motor. A second voltage level of the secondary battery may be increased using a DC/DC converter circuit, for example, to match a first voltage level of the primary battery in response to receiving a battery swap initiation signal during which the primary battery is to be electrically disconnected from the electric machine to enable second electrical power from the secondary battery to be supplied to the motor(s) therefrom.

In an embodiment, the second electrical power may be connected to at least one motor by managing connection of the secondary battery in parallel with the primary battery. When the secondary battery is successfully connected in parallel to the primary battery, the primary battery may then be disconnected from the motors. Once the primary battery is disconnected from the motors, the primary battery may be recharged. Connection of the secondary battery and disconnection of the primary battery may be performed when the power electronics manage the energy from the secondary battery to match the DC power bus voltage level. Matching the DC power bus voltage level avoids electrical damage to the primary battery, the secondary battery, and the power management device. One method that can be used to achieve this power management is to use a DC/DC converter circuit (e.g., buck/boost circuit). Other devices may be used to manage the secondary battery connection to the primary battery, including but not limited to power switching semiconductors, electrical-mechanical switching devices, or other devices known to practitioners skilled in the art.

### BRIEF DESCRIPTION OF THE FIGURES

A more complete understanding of the method and apparatus of the present invention may be obtained by reference to the following Detailed Description when taken in conjunction with the accompanying figures wherein:

FIGS. 1A and 1B are illustrations of illustrative mining machines that are electrically driven by one or more rechargeable batteries to perform hauling and digging/loading functions, respectively;

FIG. 2 is a high-level illustrative schematic of an electric machine including a swappable primary battery and a smaller secondary battery;

FIG. 3 is an illustrative signal diagram showing electrical power signals from each of a primary and a secondary battery during a swap of the primary battery;

FIG. 4 is an illustrative electrical power system including a primary battery, secondary battery, and power circuit; and

FIG. 5 is a flow diagram of an illustrative process for performing a swap of a primary battery.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

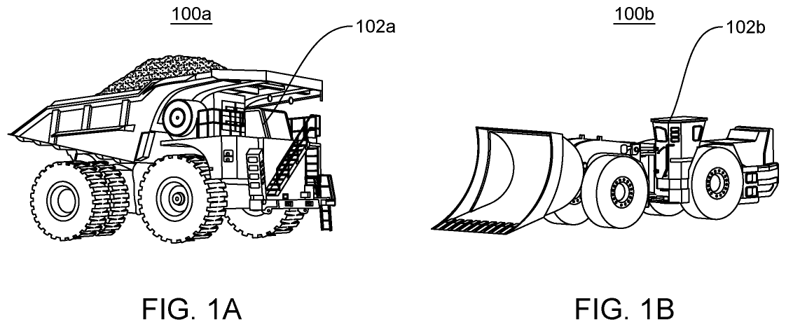

With regard to FIGS. 1A and 1B, illustrations of illustrative electric machines 100a and 100b (collectively 100), in this case mining machines, that are electrically driven by one or more rechargeable batteries (e.g., rechargeable batteries) to perform hauling and loading functions, respectively, are shown. Because these electric machines 100 are configured to perform very heavy lifting and carrying operations, the rechargeable batteries are exceptionally large due to being used to power motors of the electric machines 100 in addition to performing lift, dump, dig, and other high-torque operations. As an example, the electric machine 100a, in this case a mining truck that functions as a dump truck weighing over 400 tons are used for carrying raw materials that have been mined. The electric machine 100a may have a primary electric battery measuring 3.6 m×1.6 m×2.4 m (11.8 ft×5.25 ft×7.8 ft) that weighs thousands of kilograms (thousands of pounds) that is configured with energy storage capacity of 1.4 MWh (2,600 volts), such a large battery may still be capable of fast-charging in just 30 minutes. Despite the fast charging time, because of the scale of operations on a mining job site that the electric machine 100a is meant to be performing, any loss of operational time is exceptionally expensive. As such, there is a need to operate on a secondary battery while swapping an energy-depleted primary battery for a recharged primary battery.

As further shown, both of the electric machines 100a and 100b include operator compartments 102a and 102b (collectively 102) in which one or more human operators are positioned during operations of the respective electric machines 100. Each of the operator compartments 102 may be configured with subsystems, such as air conditioners and heaters, as the electric machines 100 are typically used in challenging environments that may be hot or cold, thereby making it desirable for the operators to be able to continue operating the subsystems when the primary batteries have been removed and are being swapped for recharged primary batteries. In an embodiment, it may take upwards of six minutes or more to perform a swap of a primary battery, so a secondary battery is to be specified to be able to support operations of the electric machines 100 and also subsystems, such as air conditioning and heating, in the operator compartments 102 or elsewhere during the swapping process.

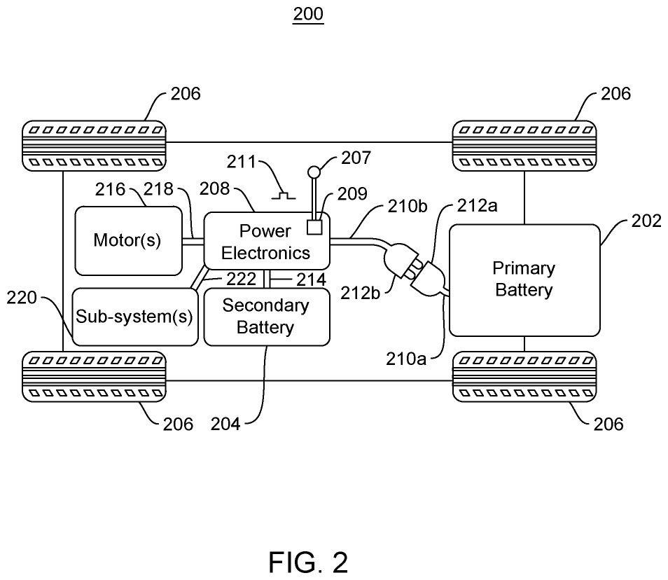

With regard to FIG. 2, a high-level illustrative schematic of an electric machine 200 including a swappable primary battery 202 and a smaller, secondary battery 204 is shown. In this case the electric machine 200 may be a vehicle that includes tires 206 used to move the electric machine 200. It should be understood that the electric machine 200 may include tracks or other systems to move the electric machine 200 along with any other mechanisms, such as scoops, hoists, or any other mechanized systems for performing a particular function or functions. It should also be understood that the electric machine 200 may be stationary and not include mechanisms that enable the electric machine 200 to be moved. The primary battery 202 may be configured to store more energy than that of the secondary battery 204, so the primary battery 202 may be physically larger than the secondary battery 200. As such, the primary battery 202 may be primarily used during normal operations of the electric machine 200, while the secondary battery 204 may be utilized to support operations of the electric machine 200 during battery swapping periods when the rechargeable primary battery 202 is energy-depleted and is being swapped with another rechargeable primary battery that is fully charged. A time period for swapping the primary battery 202 may be a limited amount of time, such as less than 10 minutes, thereby enabling the secondary battery 204 to be configured to support primary operations of the electric machine, but also one or more subsystems, such as air conditioners and/or heaters within an operator compartment. To initiate a battery swap, a push button or other battery swap activation element 207 may be provided for an operator to press or otherwise cause to initiate a battery swap process.

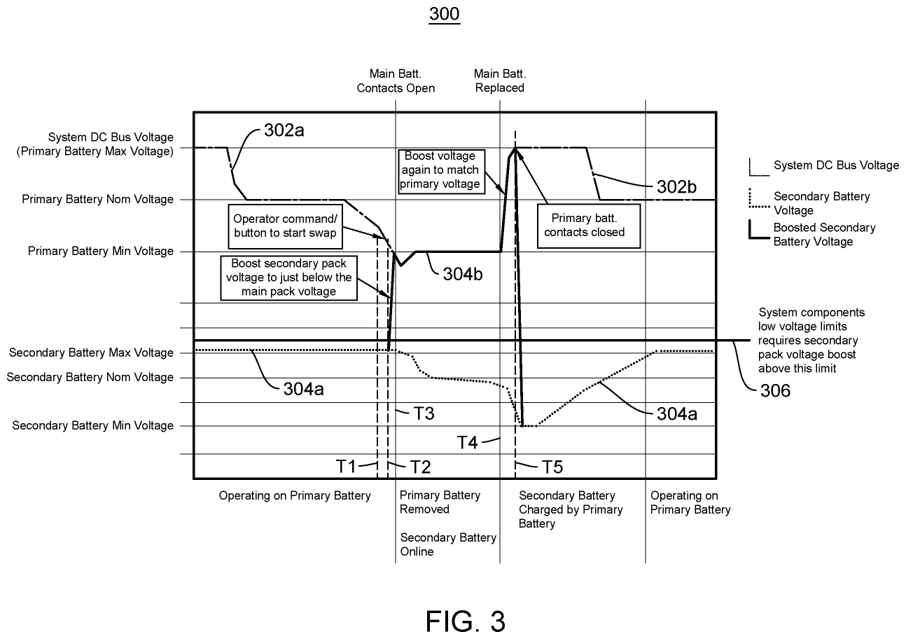

The electric machine 200 may include power electronics 208 that may be electrically connected to the primary battery 202 and secondary battery 204 so as to receive electrical power from one or both of the primary battery 202 and/or secondary battery 204. For example, (i) the primary battery 202 may be electrically connected to the power electronics 208 during normal operations, (ii) primary and secondary batteries 202 and 204 may both be electrically connected to the power electronics 208 during a transition of the primary battery 202 to the secondary battery 204 and vice versa when initiating or completing a swap of the primary battery 202, and (iii) secondary battery 204 may be electrically connected when the primary battery 202 has been electrically disconnected from the electric machine 200 during the swap of the primary battery 202. As shown, the primary battery 202 may be electrically disconnectable from the power electronics 208 so as to support swapping of the primary battery 202. In an embodiment, at least one processor 209 may be in electrical communication with and/or integrated with the power electronics 208, and be configured to control the power electronics 208 in performing a battery swap process and any other function of which the power electronics 208 and/or other systems are capable of performing. For example, the processor(s) 209 may be configured to receive a battery swap initiation signal 211 in response to a user pressing the activation element (e.g., push button) 207, which, in turn, controls the power electronics 208 to initiate the battery swap process (see, for example, FIG. 3). The power electronics 208 may include active power electronics, such as a DC/DC converter, passive power electronics such as switching diodes, electrical-mechanical devices, such as contactors, and sensors configured to sense voltage levels and current levels at various points in the power electronics, primary battery, and secondary battery.

The primary battery 202 is shown to include an electrical conductor 210a connected to an electrical connector 212a, in this case a socket. The power electronics 208 may be connected to electrical conductor 210b that connects to an electrical connector 212b, in this case a plug. It should be understood that the electrical connectors 210a and 210b (collectively 210) and electrical connectors 212a and 212b (collectively 212) are illustrative, and that other types of electrical conductors 210 and connectors 212, such as the socket and plug reversed, capacitive or inductive charge elements, etc., may be used to provide for a fast and easy swapping process to make the electrical connection of the primary battery 202 and power electronics 208. The swapping process may be automatic, semi-automatic, or manual.

The secondary battery 204 is shown to be electrically connected via an electrical conductor 214, which may be releasably or non-releasably connected between the power electronics 208 and secondary battery 204. The power electronics 208 may be electrically connected to one or more motors 216 via an electrical conductor 218. The electrical conductor 218 may be releasably or non-releasably connected to one or both of the power electronics 208 and/or motors(s) 216. Subsystems 220 (e.g., air conditioner, heater, radio, etc.) may be electrically connected to the power electronics 208 via an electrical conductor 222. It should be understood that the electrical conductors 210b, 214, 218, and/or 222 may be part of a system DC power bus of the electric machine 200 and used to power electrical and/or electronic devices (e.g., motor(s) 216, subsystems 220, controls, lights, etc.) of the electric machine 200.

With regard to FIG. 3, an illustrative signal diagram 300 showing electrical power signals 302a, 302b (collectively 302) and 304a, 304b (collectively 304) from each of a primary battery and a secondary battery on an electric machine (see FIG. 2, for example) during a swap of the primary battery is shown. The primary battery may supply electrical power (shown as voltages 302a and 302b) when the primary battery is electrically connected to system DC power bus. The voltages 304a of the secondary battery are shown when not electrically connected to the system DC power bus and voltages 304b of the secondary energy storage device when drawn on by the power electronics to connect to the DC power bus.

In operation, an operator or other user of the electric machine may instruct the electric machine that a swap primary battery process is to be performed at time T1. The instruction may be performed by the operator pressing a button or engaging any other activation device that causes a swap primary battery signal to be communicated to power electronics. In an embodiment, the swap primary battery signal may be generated by a processor (see FIG. 2) that is configured to control operations of the power electronics. The power electronics may include circuitry that activates at time T2 to draw power from the secondary battery at voltage 304a and provide that power to the DC power bus at voltage 304b to match the voltage of the primary battery. In matching the voltage level of the secondary battery with the voltage level of the primary battery, the voltage 304b may be substantially matched or slightly below that of the voltage 302a (e.g., voltage 304b within a few percent of the voltage 302a to avoid causing arcing or any other electrical phenomenon (e.g., current surge) on the system DC power bus that could negatively impact electrical and/or electronic devices on the bus). At time T3, after the voltage 304b is matched to the voltage 302a, the primary battery may be electrically disconnected from the power electronics (e.g., separate an electrical connector or transition a switch from a connected to a disconnected state to electrically disconnect the primary battery from the system DC power bus). Such a disconnection of the primary battery may be performed physically (e.g., by separating a plug from a socket of an electrical connector) or electromechanically (e.g., using an electrical or electromechanical switch).

After the primary battery is disconnected from the system DC power bus, the electric machine may be powered by the secondary battery. As previously described, the secondary battery may be configured to support the electric machine along with some or all of the subsystems (e.g., air conditioner) during the primary battery swap (e.g., six minutes or more). In an embodiment, the secondary battery may be configured to ensure that the voltage provided thereby is above a minimum low voltage level 306 (i.e., a voltage level after the voltage 304a of the secondary battery is boosted by the power electronics) during the swap period.

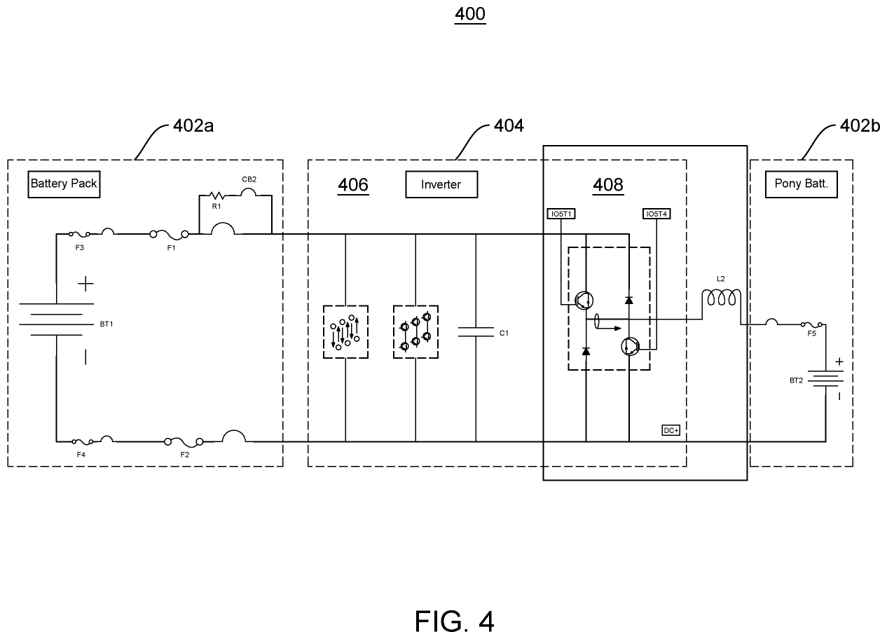

At time T4, the primary battery may be replaced by a second primary battery that is charged and be electrically connected to the system DC power bus of the electric machine. In an embodiment, the power electronics may draw power from the secondary battery to increase the DC power bus voltage 304b to match the fully charged second primary battery voltage level 302b (i.e., within a few percent). In response to the voltage level 304b of the DC power bus matching the voltage level 302b of the primary battery, the primary battery may be electrically connected to the system DC power bus and the secondary battery may be disconnected from the system DC power bus at time T5. The power electronics may further be configured to transfer power from the DC power bus to recharge the secondary battery from the charged primary battery thereafter, as provided with regard to FIG. 4, to cause the voltage 304a of the secondary battery to increase to a maximum voltage.

It should be understood that the electric machine may be configured to detect that the voltage or electrical power level of the primary battery is getting low and automatically produce a signal (e.g., visual and/or audio signal) or communicate a notification (e.g., message to a device to display a notification or generate an haptic signal, such a vibration of a mobile phone or watch) to notify an operator of the low energy level of the primary battery so as to initiate a swap of the primary battery soon.

With regard to FIG. 4, an illustrative electrical power system 400 including a primary battery 402a, secondary battery 402b, and power circuit 404 are shown. The power circuit 404 may include an inverter circuit 406 and a DC converter circuit 408 (e.g., a buck/boost circuit). As shown, the primary battery 402a may be configured as a battery pack that may be physically and electrically removably connected to the electric machine and system DC power bus, respectively. The DC converter circuit 408 may be configured (i) to recharge the secondary battery from the primary battery using the DC converter circuit and (ii) to provide power to the DC power bus to match the voltage level of the primary battery prior to the primary battery being electrically disconnected from the system DC power bus and prior to a second recharged primary battery being electrically reconnected to the system DC power bus, as described with regard to FIG. 3. The power electronics 400 may be in communication with and/or be integrated with at least one processor (see FIG. 2) that is used to control the power electronics 400, other subsystems, and optionally provide information, such as telemetry data that may include timing (e.g., countdown timing of a battery swap), primary and secondary battery energy levels, voltage levels, etc.), of the electric machine to an operator.

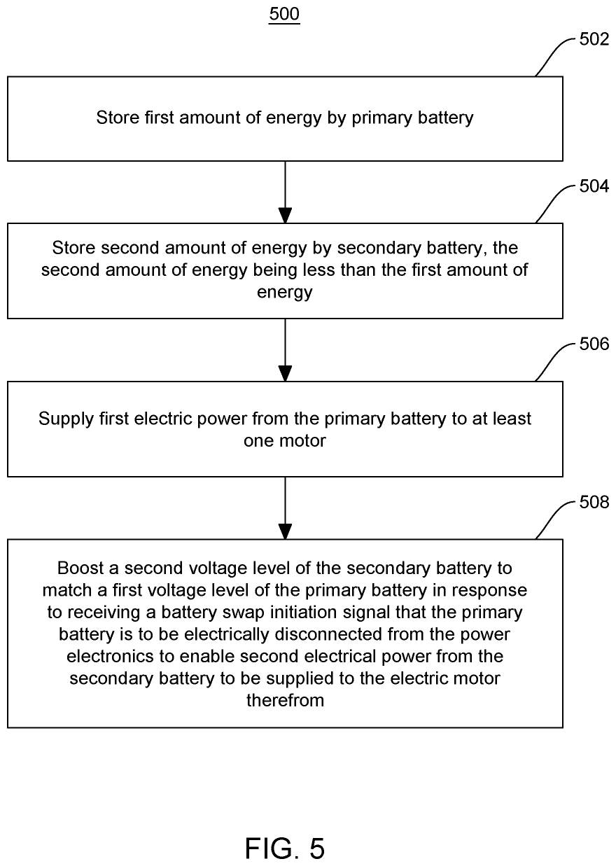

With regard to FIG. 5, a flow diagram of an illustrative process 500 for performing a swap of a primary electrical power device is shown. The process may start at step 502 where a first amount of energy may be stored by a primary battery. At step 504, a second amount of energy may be stored by a secondary battery. First electrical power may be supplied from the primary battery to at least one motor at step 506. At step 508, power from the secondary battery may be provided to the DC power bus to match a first voltage level of the primary battery in response to receiving a battery swap initiation signal during which the primary battery is to be electrically disconnected from the electric machine to enable second electrical power from the secondary battery to be supplied to the motor(s) therefrom.

One embodiment of an electric machine may include at least one electric motor. A primary battery may be configured to store a first amount of energy and be removably connected to the electric machine. A secondary battery may be configured to store a second amount of energy that is less than the first amount of energy. The electric machine may include a system DC power bus and power electronics in electrical communication with the system DC power bus with which at least one motor and the primary and secondary batteries are in electrical communication. The power electronics may be configured (i) to supply first electrical power from the primary battery to the motor(s) via the system DC power bus and (ii) to manage connection of a second voltage level of the second battery (e.g., provide power from the secondary battery at the level of the DC power bus) to match the first voltage level of the primary battery in response to receiving a battery swap initiation signal that the primary battery is to be electrically disconnected from the system DC power bus to enable second electrical power from the secondary battery to be applied to the system DC power bus to supply electrical power to the motor(s).

The primary and secondary batteries may be rechargeable batteries. The power electronics may include a DC/DC power management circuit (e.g., DC converter circuit) to manage the power into and out of the secondary battery to the system DC power bus. In an alternative configuration, the power electronics may include passive electronic devices, such as power diodes. In yet another configuration, the power electronics may include electrical-mechanical devices, such as power contactor switches. The power electronics may further be configured to recharge the secondary battery using energy from the system DC power bus supplied by the primary battery. The power electronics may further be configured to manage connection of the second battery in parallel with the primary to not electrically damage the secondary battery, the primary battery, or the power electronics in response to a second primary battery being electrically connected to the system DC power bus prior to powering the electric machine using the second primary battery. To avoid electrically damaging the secondary battery, the primary battery, or the power electronics, power drawn from the secondary battery may be provided to the system DC power bus at a voltage level to match the first voltage level of the primary battery in response to the second primary battery being electrically connected to the system DC power bus prior to powering the electric machine using the second primary battery. The power electronics may further be configured to utilize the primary battery to (i) supply electrical power to the electric machine and (ii) re-charge the secondary battery while the secondary battery is not being used to supply the electric motor(s) by not providing power to the power electronics to supply the system DC power bus.

The power electronics may be configured to manage the second voltage level of the system DC power bus voltage above a minimum voltage threshold level between the time that the primary battery that is energy-depleted is electrically disconnected from the system DC power bus and a second primary battery that is charged is connected to the system DC power bus, where the time may be at least five minutes.

The electric machine may further include a user-activated device configured to enable a user to initiate a battery swapping process to cause the power electronics to draw power from the secondary battery and apply the power to the DC power bus at a second voltage level to match the first voltage level, thereby enabling the primary battery to be electrically disconnected from the system DC power bus and another primary battery to be electrically connected to the system DC power bus. The electric machine may be a vehicle. The vehicle may be a mining vehicle. The electric machine may further include a controller with at least one processor configured to control the power electronics to initiate boosting the second voltage level.

One embodiment of a method of swapping a primary battery of an electric machine may include storing, by the primary battery, a first amount of energy. A secondary battery may store a second amount of energy that is less than the first amount of energy. First electrical power may be supplied from the primary battery to at least one motor. Power electronics may draw power from the secondary battery and apply the power to the DC power bus to match a first voltage level of the primary battery in response to receiving a battery swap initiation signal during which the primary battery is to be electrically disconnected from the electric machine to enable second electrical power from the secondary battery to be supplied to the motor(s) therefrom.

Storing the first amount and second amount of energy may include storing the first amount and second amount of energy in the primary and secondary batteries that are each a rechargeable battery. Drawing power from the secondary battery may include using a DC/DC converter to transfer the power to the DC power bus to match the first voltage level of the primary battery. The process may further include charging the secondary battery from the second primary battery after a second recharged primary battery is connected. In an embodiment, the process may further include drawing power from a secondary battery and transferring the power to the DC power bus to match the first voltage level of the primary battery in response to a second primary battery that is charged being electrically connected to the electric machine prior to powering the electric machine using the second primary battery.

The process may further include (i) supplying electrical power to the electric machine using the second primary battery that is charged and (ii) re-charging the secondary battery using energy from the second primary battery.

Drawing power from the secondary battery and providing the power to the DC power bus may include maintaining the DC power bus voltage level above a minimum voltage threshold level between the time that the primary battery that is energy-depleted is electrically disconnected from the electric machine and a second primary battery that is charged is electrically connected to the electric machine. The process may further include receiving a signal initiated by a user to initiate drawing power from the secondary battery and providing the power to the DC power bus to match the first voltage level.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. An electric machine, comprising:
at least one electric motor;
a primary battery configured to store a first amount of energy, and be removably connected to the electric machine;
a secondary battery configured to store a second amount of energy that is less than the first amount of energy;
a system DC power bus; and
power electronics in electrical communication with the system DC power bus with which the at least one motor and the primary and secondary batteries are in electrical communication, the power electronics configured (i) to supply first electrical power from the primary battery to the at least one motor via the system DC power bus and (ii) to manage connection of a second voltage level of the secondary battery to match a first voltage level of the primary battery in response to receiving a battery swap initiation signal that the primary battery is to be electrically disconnected from the system DC power bus to enable second electrical power from the secondary battery to be applied to the system DC power bus to supply electrical power to the at least one motor.

2. The electric machine according to claim 1, wherein the primary and secondary batteries are rechargeable batteries.

3. The electric machine according to claim 1, wherein the power electronics include a DC/DC power management circuit to manage the power applied from the secondary battery to the system DC power bus.

4. The electric machine according to claim 1, wherein the power management circuit is further configured to recharge the secondary battery using energy from the system DC power bus supplied by the primary battery.

5. The electric machine according to claim 1, wherein the power electronics are further configured to manage connection of the secondary battery in parallel with the primary battery to not electrically damage the secondary battery, the primary battery, or the power electronics in response to a second primary battery being electrically connected to the system DC power bus prior to powering the electric machine using the second primary battery.

6. The electric machine according to claim 5, wherein the power electronics are further configured to utilize the primary battery to (i) supply electrical power to the electric machine and (ii) re-charge the secondary battery while the secondary battery is not being used to supply the at least one electric motor.

7. The electric machine according to claim 1, wherein the power electronics are configured to manage the second voltage level of the DC power bus above a minimum voltage threshold level between a time that the primary battery that is energy-depleted is electrically disconnected from the system DC power bus and a second primary battery that is charged is connected to the system DC power bus.

8. The electric machine according to claim 7, wherein the time is at least five minutes.

9. The electric machine according to claim 1, further comprising a user-activated device configured to enable a user to initiate a battery swapping process to cause the power electronics to manage the second voltage level to allow the primary battery to be disconnected from the system DC power bus without electrical damage and another primary battery to be connected to the system DC power bus without electrical damage.

10. The electric machine according to claim 1, wherein the electric machine is a vehicle.

11. The electric machine according to claim 10, wherein the vehicle is a mining vehicle.

12. The electric machine according to claim 1, further comprising a controller with at least one processor configured to control the power electronics to initiate managing the second voltage level.

13. A method of swapping a primary battery of an electric machine, comprising:
storing, by the primary battery, a first amount of energy;
storing, by a secondary battery, a second amount of energy that is less than the first amount of energy;
supplying first electrical power from the primary battery to at least one motor via a system DC power bus; and
supplying second electrical power from the secondary battery to the system DC power bus to match the first voltage level of the primary battery in response to receiving a battery swap initiation signal during which the primary battery is to be electrically disconnected from the electric machine to enable second electrical power from the secondary battery to be supplied to the at least one motor therefrom.

14. The method according to claim 13, wherein storing the first amount and second amount of energy includes storing the first amount and second amount of energy in the primary and secondary batteries that are each rechargeable batteries.

15. The method according to claim 13, wherein supplying second electrical power from the secondary battery includes using a DC converter circuit to supply the second electrical power of the secondary battery to the DC power bus to match a first voltage level of the primary battery.

16. The method according to claim 13, further comprising charging the secondary battery from the primary battery.

17. The method according to claim 13, wherein supplying second electrical power from the secondary battery includes supplying the secondary electrical power to the system DC power bus by matching the first voltage level of the primary battery in response to a second primary battery that is charged being electrically connected to the electric machine prior to powering the electric machine using the second primary battery.

18. The method according to claim 17, further comprising (i) supplying electrical power to the electric machine using the second primary battery that is charged and (ii) re-charging the secondary battery using energy from the second primary battery.

19. The method according to claim 13, wherein supplying the second electrical power from the secondary battery to the DC power bus includes maintaining the system DC power bus above a minimum voltage threshold level between a time that the primary battery that is energy-depleted is electrically disconnected from the electric machine and a second primary battery that is charged is electrically connected to the electric machine.

20. The method according to claim 13, further comprising receiving a signal initiated by a user to initiate supplying the second electrical power from the secondary battery and providing the second electrical power to the DC power bus to match the first voltage level.
